(19) United States
(12) Patent Application Publication
(10) Pub. No.: US 2009/0170552 A1
(43) Pub. Date: Jul. 2, 2009

(54) METHOD OF SWITCHING PROFILES AND RELATED MOBILE DEVICE

(76) Inventor: Jian-Liang Lin, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/274,368

(22) Filed: Nov. 20, 2008

(30) Foreign Application Priority Data
Dec. 31, 2007 (TW) 096151640

(51) Int. Cl. H04M 1/00

(52) U.S. Cl. 455/550.1

(57) ABSTRACT

To switch a profile in a mobile device, the mobile device captures an input when the mobile device detects a predetermined condition, and the mobile device switches the profile according to the input. The predetermined condition could include detection of motion or rest, or recurring update periods. Examples of inputs captured include digital images, sounds, videos, location, and time.

### BACKGROUND OF THE INVENTION

1. Field of the Invention

The present invention relates to methods of switching profiles in mobile devices, and more particularly, to a method of switching a profile in a mobile device based on time, date, location, or environmental factors.

2. Description of the Prior Art

Mobile devices, such as mobile phones, PDAs, and smartphones, offer great convenience to users by allowing users to access communications and organization functions at any time and any place. In addition, most mobile devices are designed small enough to be carried in a pocket or clipped to a belt.

For this reason, mobile devices often accompany their users at all times. Most mobile devices include speakers for notifying users of incoming calls, scheduled events, and low battery charge. Unfortunately, if any of these notifications goes off while the user is at work, in a meeting, or at an important event, such as a wedding, disruption of the event, and consequent embarrassment of the user, ensues.

A number of options are available for the user to prevent such disruptions, including turning off the mobile device, muting the mobile device, activating a vibration feature, or some combination of these options. For example, the user may choose to mute all battery status notifications, but vibrate on incoming calls. Most mobile devices now include customizable “profiles,” which are used to define how the mobile device handles each type of notification event. Please refer to FIG. 1, which is a diagram of profile options of various profiles for the mobile device. Depending on the environment the user is in, the user can select an appropriate profile, which includes settings such as volume, silent mode, vibration, and answering mode. If the user is in a meeting, the volume is turned off, silent mode is on, and vibration is on as long as silent mode remains on. If the user is in the car, then the volume is on, vibration is off, and the user can answer incoming calls with any key. The user can also customize each profile to suit their environment, or create new profiles.

While the creation, customization, and selection of the appropriate profile for each environment is a large step in the right direction, the user is very likely to forget to switch profiles when they change environments. So, the user may continue to use the meeting profile when they are driving, such that they miss calls, or have to look for the answer call key while driving, which is dangerous. Or, the user may forget to switch profiles before a meeting, and the mobile device may ring or make noises during the meeting, defeating the purpose of having the profiles in the first place.

### SUMMARY OF THE INVENTION

According to the present invention, a method of switching a profile in a mobile device comprises the mobile device capturing an input when the mobile device detects a predetermined condition, and the mobile device switching the profile according to the input.

According to a second embodiment of the present invention, a method of switching a profile in a mobile device comprises the mobile device capturing an input when the mobile device detects a motion of the mobile device, and the mobile device selectively switching the profile according to the input.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of profile options for a mobile device according to the prior art.

FIG. 2 is a diagram of switching a profile in a mobile device according to an embodiment of the present invention.

FIG. 3 is a diagram of a mobile device with a switchable profile according to an embodiment of the present invention.

### DETAILED DESCRIPTION

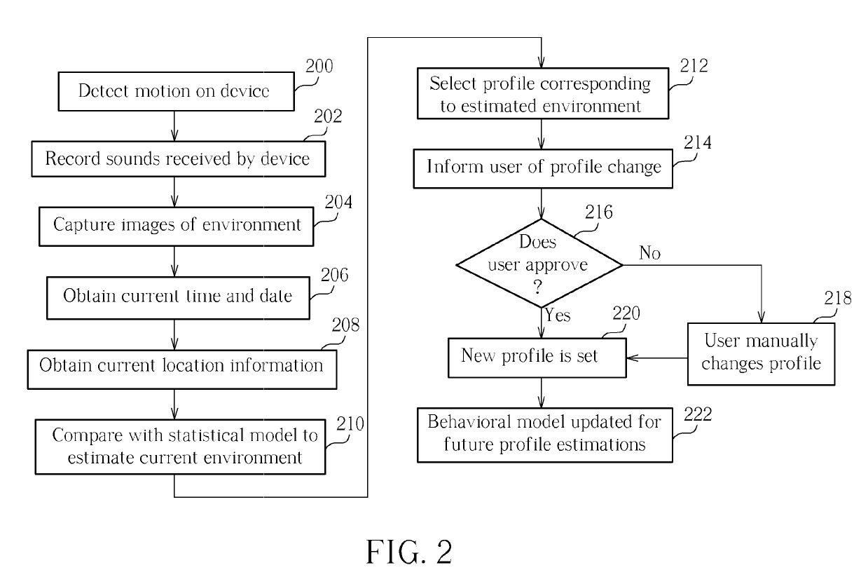

Please refer to FIG. 2, which is a flowchart of a method used for switching a profile in a mobile device according to the present invention. The method begins with detecting motion on a device, such as the mobile device mentioned above (Step 200). When motion is detected, the device may proceed to perform a number of steps to obtain information about its current environment. The device can record sounds through a microphone (Step 202), capture images of the environment through a camera (Step 204), obtain current time and date information (Step 206), or even obtain location information, e.g. through a GPS receiver (Step 208). The device can perform any combination of the above steps (Steps 202-208) to obtain information about its current environment. Then, based on the information obtained, the device may compare the information with a statistical model to estimate the current environment (Step 210).

In Step 200, the mobile device detects motion of the mobile device. The motion may be detected when the mobile device begins moving from a state of rest, or when the mobile device stops moving from a state of motion. Other more refined methods of motion detection could also be employed, which take into account degrees of acceleration, acceleration along particular axes, etc. Further, instead of triggering the following steps of the method (Steps 202-208) by detecting motion, the mobile device could use a timer to activate the following steps (Steps 202-208) periodically. Other simple triggers, involving low power consumption light, heat, or sound sensors could also be used to detect a change in the environment. The mobile device may also utilize changes in the time to determine when to activate a profile change. For example, if the mobile device has been stationary for a long period of time after work, the profile may be changed from a home profile to a sleep profile. The following steps (Steps 202-210) may also be activated through a button press, such as an “auto-profile” button, which the user may press to tell the mobile device to determine on its own which profile to set depending on the current environment.

After the mobile device obtains some combination of audio, image, time/date, and location data from Steps 202-208, the mobile device may compare the data obtained with the statistical model (Step 210). For example, amplitude of the audio data obtained in Step 202 may be used to determine if the user is outdoors or in a building. Certain types of sounds, such as car engines and honking noises may indicate that the user is outdoors. On the other hand, a low volume level, or a low instance of human voices, may indicate that the user is in a meeting, in the office, or at a theater. The image data obtained in Step 204 may have fluorescent lighting, which may indicate an indoor location, or natural lighting that may indicate an outdoor location. Low lighting may indicate a concert hall or movie theater. The image data and audio data may also include video data, which may include flicker of light sources or other recognizable characteristics. Using the current time and date data obtained in Step 206, the mobile device may determine that the user is at work, in the car, or at home. If the current date falls on a weekend, then the user may not be at work. In conjunction with a calendar/scheduler application, the mobile device may determine that the user is in a meeting, at lunch with a client, or at a theatrical performance from events programmed into the scheduler. Finally, if the mobile device has a GPS unit, the location data obtained in Step 208 may be used to determine that the user is at their desk, in a conference room, in the car, at the theater, in church, or at any number of locations that are recognized by the GPS unit.

Based on the comparison with the statistical model, the mobile device then approximates the current environment in Step 210, and selects a corresponding new profile that is appropriate for the environment the mobile device is in (Step 212). If the mobile device is in the office, the mobile device may select the office profile. If the mobile device is in a meeting, then it may select the meeting profile. As the mobile device may be making an approximation or estimate of where it is located, such that the location may be uncertain, the mobile device may further inform the user that it is changing to the new profile (Step 214). If the user approves of the profile change (Step 216), the mobile device applies the new profile (Step 220), and the behavioral model is updated (or learns) for future profile estimations (Step 222). On the other hand, if the user does not approve of the profile change, the user may manually select an appropriate new profile they feel fits the current environment, or simply keep the previous profile, and the mobile device may then set the new profile, or do nothing, and update the behavioral model accordingly.

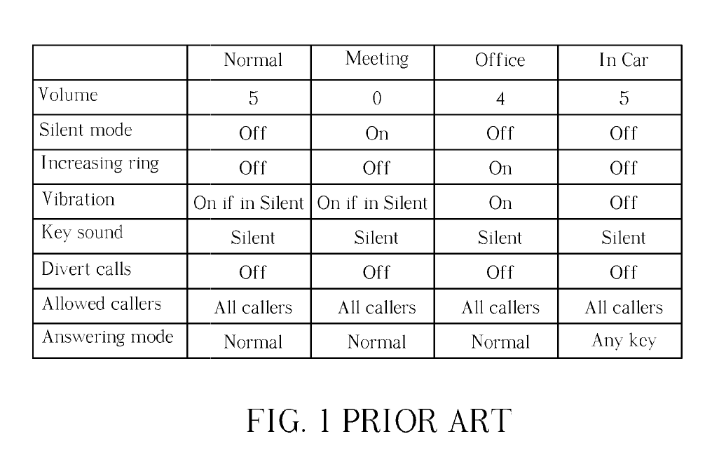

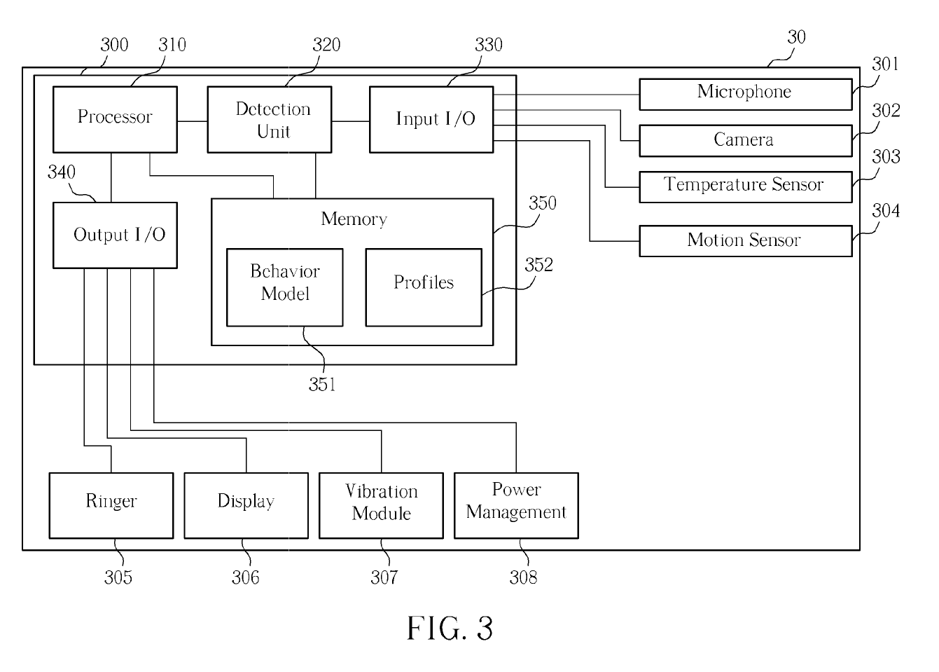

Please refer to FIG. 3, which is a diagram of a mobile device 30 with a switchable profile according to an embodiment of the present invention. The mobile device 30 may comprise a control circuit 300, and a plurality of output and input devices 301-308. Based on input from the plurality of input devices 301-304, the control circuit 300 may select a profile 352 for controlling the plurality of output devices 305-308. As shown, the control circuit 300 may comprise a processor 310, a detection unit 320, an input I/O 330, an output I/O 340, and memory 350. The detection unit 320 may receive and process signals from a microphone 301, a camera 302, a temperature sensor 303, and/or a motion sensor 304, etc., through the input I/O 330. Types of detection may include those described in Steps 200 to 208 shown in FIG. 2. Then, based on behavior models 351 stored in the memory 350, the detection unit 320 may generate a detection result that may be passed to the processor 310. The processor 310 may then select an appropriate profile 352 from the memory 350 based on the detection result. The profile 352 may correspond to the profiles shown in FIG. 1, and may be utilized by the processor 310 for modifying behavior of a ringer 305, a display 306, a vibration module 307, and/or a power management module 308, etc. For example, based on the profile 352, the processor 310 may set a ring volume of the ringer 305 higher or lower, turn vibration of the vibration module 307 on or off, increase or lower backlight intensity of the display 306, or activate a power-saving mode of the power management module 308. The processor 310 may also be utilized to update the behavior model 351.

Compared to the prior art, which leaves responsibility for making appropriate profile changes up to the user, the present invention enables the mobile device to determine the appropriate profile automatically, which is a great convenience to the user, and reduces the likelihood of missing a call or interrupting an important event.

Those skilled in the art will readily observe that numerous modifications and alterations of the device and method may be made while retaining the teachings of the invention.

What is claimed is:

1. A method of switching a profile in a mobile device, the method comprising:
the mobile device acquiring an input when the mobile device detects a predetermined condition; and
the mobile device switching the profile according to the input.

2. The method of claim 1, wherein the predetermined condition comprises a button press, passage of a predetermined period of time, motion of the mobile device, changing from a motion state to a static state, or reaching a voice variance threshold.

3. The method of claim 1, wherein the predetermined condition comprises lack of motion of the mobile device.

4. The method of claim 1, wherein capturing the input comprises receiving a sound, capturing a digital image, recording a time or a date, detecting the temperature, recording location data, or recording a video.

5. The method of claim 1, wherein the mobile device switching the profile according to the input comprises:
the mobile device comparing the input to a statistical model or a value to determine a probable environment; and
the mobile device selecting a predetermined profile corresponding to the probable environment.

6. A computer-readable medium comprising instructions which, when executed, cause the computer to:
acquire an input when the computer detects a predetermined condition; and
switch a profile according to the input.

7. The computer-readable medium of claim 6, wherein the predetermined condition comprises a button press, passage of a predetermined period of time, motion of the mobile device, changing from a motion state to a static state, or reaching a voice variance threshold.

8. The computer-readable medium of claim 6, wherein the predetermined condition comprises lack of motion of the computer.

9. The computer-readable medium of claim 6, wherein capturing the input comprises receiving a sound, capturing a digital image, recording a time or a date, detecting the temperature, recording location data, or recording a video.

10. The computer-readable medium of claim 6, wherein switching the profile according to the input comprises:
comparing the input to a statistical model or a value to determine a probable environment; and
selecting a predetermined profile corresponding to the probable environment.

11. A mobile device capable of switching a profile thereof, the mobile device comprising:
at least one input device for capturing an environmental variable;
a memory storing a behavioral model and at least one profile;
a detection unit for coupled to the input device and the memory for generating a detection result according to the environmental variable and the behavioral model;
at least one output device; and
a processor coupled to the memory, the detection unit, and the output device for selecting the profile according to the detection result and controlling behavior of the output device according to the profile.

12. The mobile device of claim 11, wherein the at least one input device comprises a microphone, a camera, a temperature sensor, or a motion sensor.

13. The mobile device of claim 11, wherein the at least one output device comprises a ringer, a vibration module, a display, or a power management unit.

14. A method of switching a profile in a mobile device, the method comprising:
the mobile device capturing an input when the mobile device detects a motion of the mobile device; and
the mobile device selectively switching the profile according to the input.

15. The method of claim 14, wherein capturing the input comprises recording a sound, capturing a digital image, or recording a video.

16. The method of claim 14, wherein the mobile device switching the profile according to the input comprises:
the mobile device comparing the input to a statistical model to determine a probable environment; and
the mobile device selecting a predetermined profile corresponding to the probable environment.
